(19) United States
(12) Patent Application Publication
(10) Pub. No.: US 2025/0255426 A1
(43) Pub. Date: Aug. 14, 2025

(54) VARIABLE BRANCH ARTIFICIAL TREE AND METHODS OF ASSEMBLING

(71) Applicant: Belgravia Wood Limited, Central (HK)

(72) Inventors: Eric SZWEDA, Central (HK); Chin Yin LEUNG, Central (HK)

(73) Assignee: Belgravia Wood Limited, Central (HK)

(21) Appl. No.: 18/856,364

(22) PCT Filed: Apr. 14, 2023
(86) PCT No.: PCT/IB2023/053855

§ 371 Date: Oct. 11, 2024

Related U.S. Application Data
(60) Provisional application No. 63/363,009, filed on Apr. 14, 2022.

(51) Int. Cl. A47G 33/06; A47G 33/08; F21S 4/10

(52) U.S. Cl. CPC A47G 33/06; F21S 4/10; A47G 2033/0827

(57) ABSTRACT

Disclosed herein are systems and methods for a variable branch artificial tree. The variable branch artificial tree comprises a removably connected branch comprising at least one twig member and a branch connector. Further the variable branch artificial tree comprises a tree trunk component or section comprising a first branch receptacle and a second branch receptacle. The branch connector can be removably inserted into the first branch receptacle to enable secure coupling of the removably connected branch and the tree trunk component or section. Furthermore, the first branch receptacle is adjacent to the second branch receptacle and at a different height on the tree trunk component than the second branch receptacle.

### TECHNICAL FIELD

The present disclosure generally relates to festive goods and holiday decorations and, more particularly, variable branches for artificial trees. The variable branches can enable easy tree assembly and disassembly of an artificial tree. Furthermore, the variable branches enable a reduced overall storage volume of the artificial tree when disassembled. The disclosed invention also enables a more realistic looking artificial tree.

### BACKGROUND

The present disclosure relates in general to an artificial tree, and more specifically, to removably connected branches that can be removably attached to the tree trunk to assemble the artificial tree.

It is known in the prior art that there are artificial trees. Most artificial trees are created to resemble real trees. These artificial trees differ in construction and assembly methods. Many artificial trees have multiple sections with branches joined to a pole section and the branches are pre-affixed to the pole section. Consumers can then assemble these trees at home or the location of display by joining the sections of the artificial tree. Some of these trees also come with pre-strung lighting. Many artificial trees assembled with this design are heavy and difficult to assemble for some consumers due to the weight and size of the various sections.

The present disclosure differs from the above referenced disclosures and others that are similar in that the present disclosure reduces the storage volume for the artificial tree when disassembled, provides for easier assembly and disassembly, and enhances realism.

### SUMMARY

Embodiments of the disclosure provide a variable branch artificial tree. The variable branch artificial tree comprises a removably connected branch comprising at least one twig member and a branch connector. Further the variable branch artificial tree comprises a tree trunk component or section comprising a first branch receptacle and a second branch receptacle. The branch connector can be removably inserted into the first branch receptacle to enable secure coupling of the removably connected branch and the tree trunk component or section. Furthermore, the first branch receptacle is adjacent to the second branch receptacle and at a different height on the tree trunk component than the second branch receptacle.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a perspective view of the tree trunk and multiple removably connected branches connected to the tree trunk;

FIG. 2A is an enlarged perspective view of the tree trunk and multiple removably connected branches connected to the tree trunk;

FIG. 2B is a perspective view of the tree trunk of the present disclosure with receptacles at different elevations;

FIG. 3 is a perspective view of the tree trunk, displaying the receptacle ring of receptacles;

FIG. 4 is a perspective view of an embodiment of the tree trunk of the present disclosure and the receptacle ring of receptacles;

FIG. 5 is a perspective view of multiple tree trunks, displaying the receptacle ring of receptacles locked into place by the ring of collars and shows the electrical plug;

FIG. 6 is a perspective view of the tree trunks connected to one another;

FIG. 7 is a perspective view of the branch stems connected to the branch connectors, above the tree trunk before the branch connectors are inserted into the receptacles;

FIG. 8 is a perspective view of the branch connectors inserted into the receptacles;

FIG. 9 is a perspective view of the tree trunk of the present disclosure with the branch connectors inserted into the receptacles and displays the electrical plug;

FIG. 10 is a perspective view of an embodiment of the removably connected branch of the present disclosure;

FIG. 11 is a perspective view of the ring of collars attached to the receptacle ring of receptacles;

FIG. 12 is an embodiment of the removably connected branch of the present disclosure;

FIG. 13 is an enlarged perspective view of one of the removably connected branches, displaying the branch connector;

FIG. 14 is a perspective view of the removably connected branch and the lighting elements for each branch, including the light strings, and the light components;

FIG. 15 is a perspective view of an embodiment of the tree trunk of the present disclosure and the receptacle ring of receptacles;

FIG. 16 is a perspective view of the tree trunk and one of the removably connected branches, displaying how the branch connector is inserted into the receptacle;

FIG. 17 is a perspective view of one of the removably connected branches connected to the tree trunk;

FIG. 18 is a perspective view of two of the removably connected branches connected to the tree trunk;

FIG. 19 is a perspective view of multiple of the removably connected branches connected to the tree trunk;

FIG. 20 is a perspective view of the tree trunk of the present disclosure with a ring of collars; and

FIG. 21 is a perspective view of multiple tree trunk elements connected to multiple removably connected branches; and

FIG. 22 is an enlarged view of the branch stems connected to the branch connectors, which are inserted into the receptacles and the ring of collars is locked into place.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. The terms and definitions provided herein control, if in conflict with terms or definitions incorporated by reference.

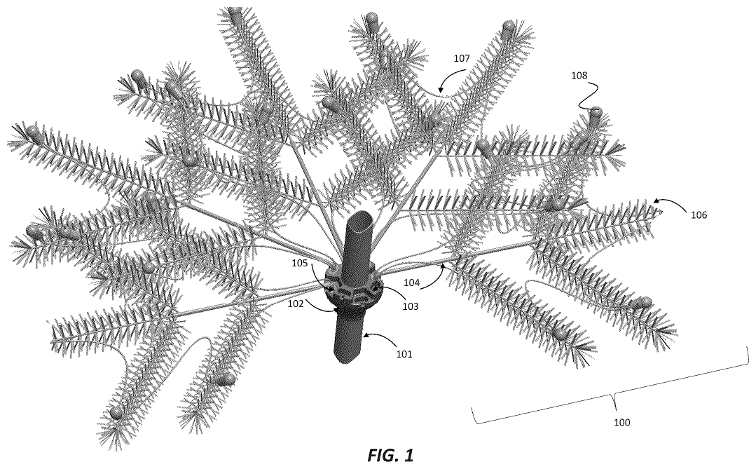

Removably connected branches 100 are generally shown in FIG. 1, connected to a tree trunk component 101. As shown in the embodiment in FIG. 1, each removably connected branch 100 can include a branch stem 104. In the embodiment show in FIG. 1, the removably connected branch 100 includes branch stem 104, branch connector 105, and twig members 106. In the embodiment shown in FIG. 1, each branch stem 104 is connected to a receptacle ring 102 in communication with the tree trunk component 101. Furthermore, in the embodiment shown in FIG. 1, each branch connector 105 is inserted into a branch receptacle 103 provided by the receptacle ring 102. Tree trunk component 101 can be constructed out of PVC, other plastics, man-made composites or fibers, wood, metal or other hard materials that can maintain the structural integrity of the tree trunk component. In some embodiments, the branch stem 104 can be comprised of a metal, plastic, or other hard materials that can maintain the structural integrity of the branch stem. In some embodiments, the twig members 103 can be comprised of polyvinyl chloride (“PVC”), polyethylene (“PE”), other plastics, or other hard materials. In the embodiment shown in FIG. 1, the removably connected branch 100 is provided with pre-strung light strings 107 and light components 108. In alternative embodiments, the removably connected branch 100 is not provided with light strings or other lighting components.

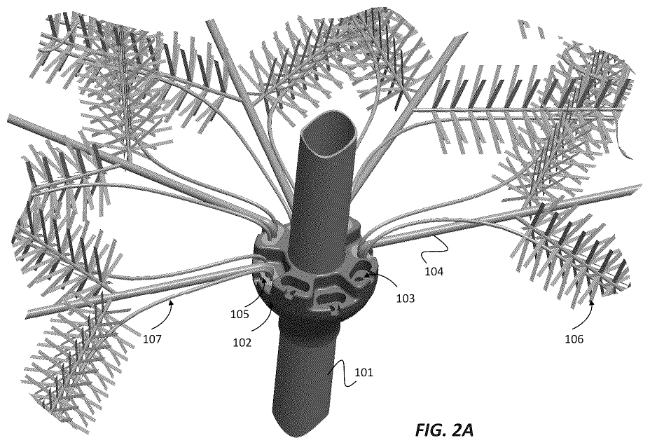

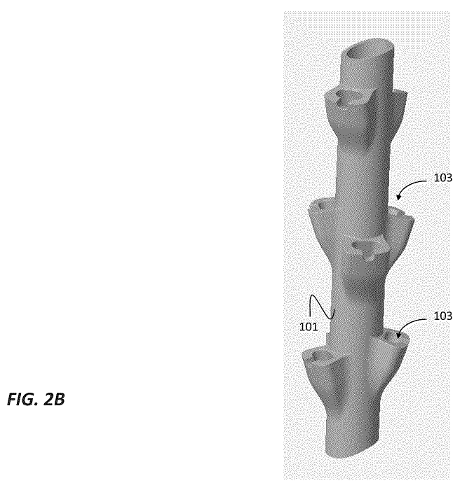

As shown in greater detail in FIG. 2A, each of removably connected branches 100 comprises at least one branch connector 105. In the embodiment shown in FIG. 2A, the branch connectors 105 are removably inserted into branch receptacles 103 in the tree trunk component 101. As shown in FIG. 2A, the relative height of the branch receptacles 103 on the receptacle ring 102 can vary. The varied height of the removably connected branches 100 in accordance with present disclosure can more closely emulate the varied elevation of the branches of a natural tree; thus, the artificial tree enabled by the present disclosure can more closely resemble a natural tree. Artificial trees are often more beneficial than natural trees because they may be used each year and reduce the annual expense, waste, and environmental impact associated with the use of live trees. However, consumers desire to maintain the look of a natural tree and the aesthetic of a natural tree. Embodiments of the present disclosure allow consumers to add each branch; thus, the removably connected branch 100 can be placed at varied elevations. The variable and more random location of the removably connected branches 100 emulates the look of a natural tree over previous designs. The branch placement feature enables the consumer to change or insert branches of their choice; thus, allowing consumers to mimic the look of a natural tree based on personal preference. In other embodiments, the branch receptacles 103 can be more randomly or sporadically placed about the tree trunk components 101 to provide a more realistic looking tree.

FIG. 2B illustrates an alternative embodiment of the tree trunk component 101, that comprises branch receptacles 103. In the embodiment shown in FIG. 2B, the branch receptacles 103 are integral to the tree trunk component 101. Furthermore, in this embodiment, the branch receptacles 103 are not provided in a receptacle ring 102. In the embodiment shown in FIG. 2B, the branch receptacles 103 are placed at various locations about the tree trunk component 101. The location of the branch receptacles 103 in this embodiment can be more randomly located to enable are more realistic look that more closes emulates the random location of the branches on a real tree. In some embodiments, the branch receptacles 103 are sparsely positioned about the tree trunk component 101 to emulate a real tree with fewer limbs. In other embodiments, more branch receptacles 103 can be provided on the tree trunk component 101 in sporadic locations to emulate the aesthetic of random branch placement on a real tree. The consumer does not have to connect a removably connected branch 100 into every branch receptacle 103 of the tree trunk component 101, as the variable branch artificial tree enable the user to customize the look of the tree at the point of assembly. In some embodiments, a branch receptacle cap can be provided with the tree trunk component 101 to be inserted into any unused branch receptacles 103 on the tree trunk component 101. Once inserted into the branch receptacle 103, the branch receptacle cap can emulate and provide the aesthetic of a knot in the tree trunk component 101.

Embodiments of the present disclosure enable an artificial tree that can be customized by the consumer at the point of assembly. For example, the consumer could choose to assemble a sparser looking tree with fewer removably connected branches 100 for one decorating season. Furthermore, in the next decorating season, the consumer may choose to connect all the removably connected branches 100 to the tree trunk component 101 to provide a dense aesthetic to the tree. Embodiments of the present disclosure also enable the consumer to have multiple sets of removably connected branches 100 for a single variable branch artificial tree. For example, a first set of removably connected branches 100 could provide evergreen style branches, a second set of removably connected branches 100 could provide branches with flocking, a third set of removably connected branches 100 could provide a fail foliage aesthetic, and a fourth set of removably connected branches 100 could be themed and exhibit colors for specific holidays and or celebrations, such as Valentine's Day, St. Patrick's Day, July 4^{th}, and Halloween. Accordingly, a single variable branch artificial tree could be configured by the consumer for many different styles of tree decoration or blends of different styles of tree decoration.

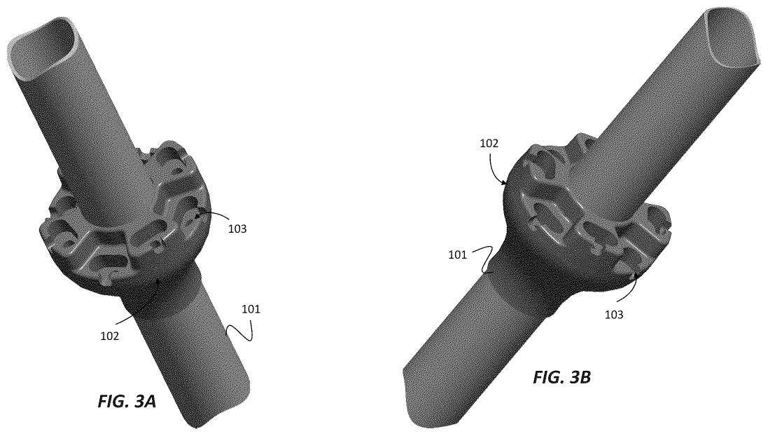

As shown in greater detail in FIGS. 3A and 3B, embodiments of the tree trunk component 101 can provide a receptacle ring 102 with branch receptacles 103 at different elevations. In some embodiments, the tree trunk component 101 can comprise the entire trunk of the artificial tree, and in other embodiments, the tree trunk component 101 is just one component of the entire trunk of the artificial tree. In the embodiment shown in FIGS. 3A and 3B, the tree trunk component 101 provides branch receptacles 103 for receiving the branch connectors 105. In the embodiment shown in FIGS. 3A and 3B, the branch receptacles 103 are provided in a receptacle ring 102. The receptacle ring 102 can be provided in communication with tree trunk component 101. In some embodiments, the branch receptacles 103 provide apertures that are complementary in shape to the branch connectors 105. The complementary shape enables the branch connectors 105 to be securely and removably installed into the branch receptacles 103.

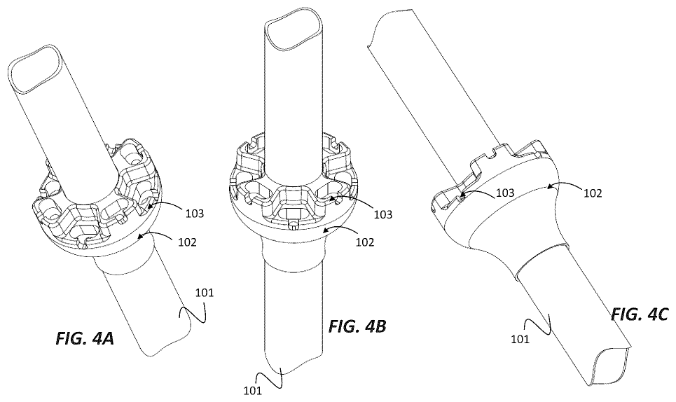

As shown in FIGS. 4A-4C, the receptacle ring 102 can provide multiple branch receptacles 103. Furthermore, the receptacle ring 102 can provide the branch receptacles 103 in varying heights in relation to the tree trunk component 101. The varied height of the branch receptacle 103 can enable the assembled artificial tree to provide a more realistic aesthetic due to varied height and location of the removably connected branches 100.

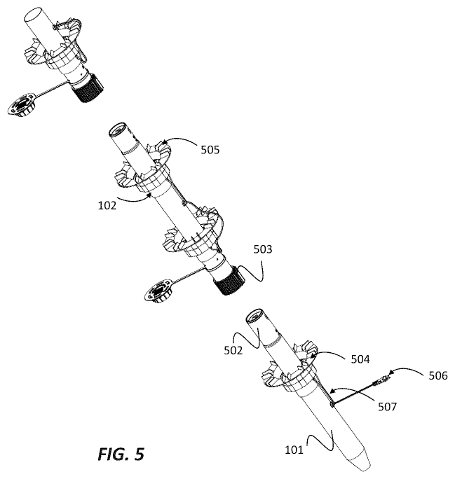

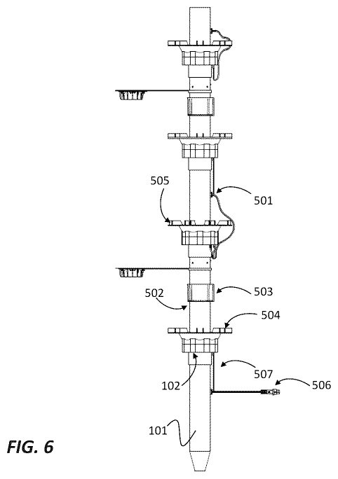

FIGS. 5 and 6 depicts an alternative embodiment of the receptacle ring 102. The receptacle ring 102 provides collars 505 on collar ring 504 to restrict the lateral movement of the removably connected branches 100. Each collar ring 504 can be securely connected to the receiving ring 102 of the tree trunk component 401. Further, the embodiment in FIGS. 5 and 6 shows how tree trunk components 101 may be connected to each other by connecting the distal end 503 of one tree trunk component 101 to the proximal end 503 of another tree trunk component 101. Furthermore, in the embodiment shown in FIGS. 5 and 6, the tree trunk component 101 can provide electrical wires 507 in communication with an electrical plug 506. In some embodiments, electrical plug 506 can be connected to a power source to provide power to electrical wires 507. Furthermore, in some embodiments, this may provide electrical power to the light strings 107 on removably connected branches 100 connected to receptacle ring 102. Accordingly, in some embodiments, light components 108 on the removably connected branches 100 may be illuminated using electrical wires 507 and electrical plug 506 when electrical plug 506 is plugged into an electrical outlet.

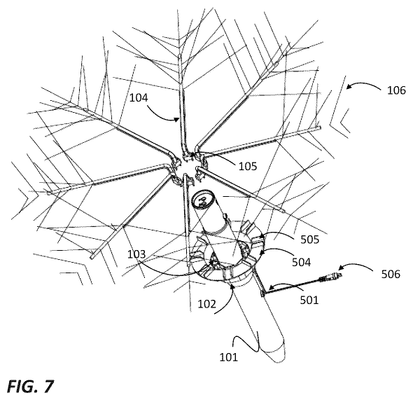

As shown in the embodiment depicted in FIG. 7, the receptacle ring 102 connected to tree trunk component 101 can include a collar ring 504. FIG. 7 further depicts how branch connectors 105 may be inserted into branch receptacles 103 of receptacle ring 102. Once connected, the movement of the removably connected branches 100 can be restricted by the collars 505 of the receptacle ring 102. In alternative embodiments, a collar ring 504 may not be connected to receptacle ring 102.

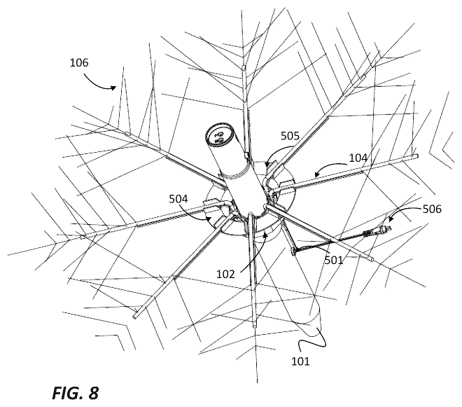

As shown in the embodiment depicted in FIG. 8, the receptacle ring 102 connected to tree trunk component 101 can include a collar ring 504. Branch connectors 105 can be inserted into branch receptacles 103.

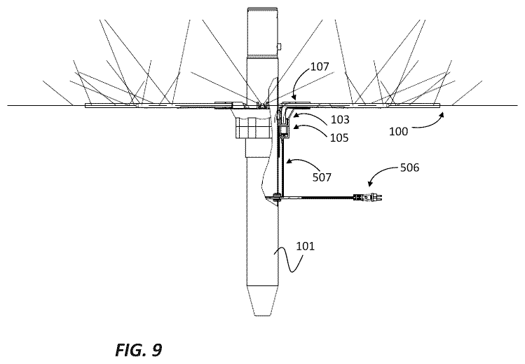

FIG. 9 depicts an alternative view of branch connectors 105 inserted into branch receptacles 103. As shown in FIG. 9, the electrical wire 107 of the removably connected branch 100 can be connected to the electrical wire 507 of the tree trunk component 101. Furthermore, in the embodiment shown in FIG. 9 the tree trunk component 101 can provide electrical wires 507 in communication with an electrical plug 506. In some embodiments, electrical plug 506 can be connected to a power source to provide power to electrical wires 507 and thus the light string 107 provided with removably connected branch 100. Accordingly, in some embodiments, light components 108 on the light string 107 may be illuminated using electrical wires 507 and electrical plug 506 when electrical plug 506 is plugged into an electrical outlet.

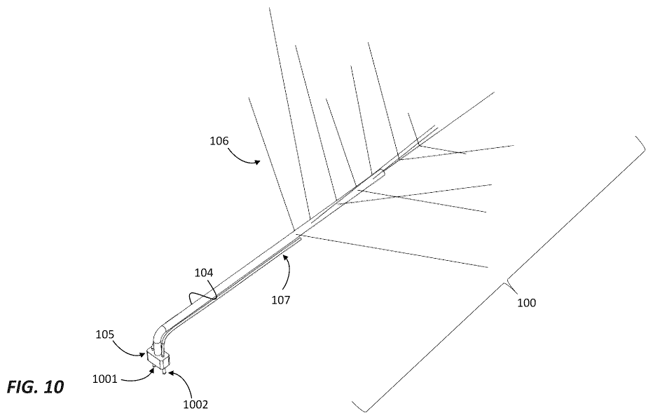

An embodiment of the removably connected branch 100 is generally depicted in FIG. 10. In the embodiment shown in FIG. 10, the removably connected branch 100 comprises branch stem 104, branch connector 105, light string 107, and twig members 106. As shown in the embodiment in FIG. 10, the branch connector 105 can include a hot terminal 1001 and a neutral terminal 1002, as termination points for the light string 107. In some embodiments, the hot terminal 1001 and a neutral terminal 1002 can be connected to corresponding terminals in the branch receptacle 103 such that power can be provided to the light string 107.

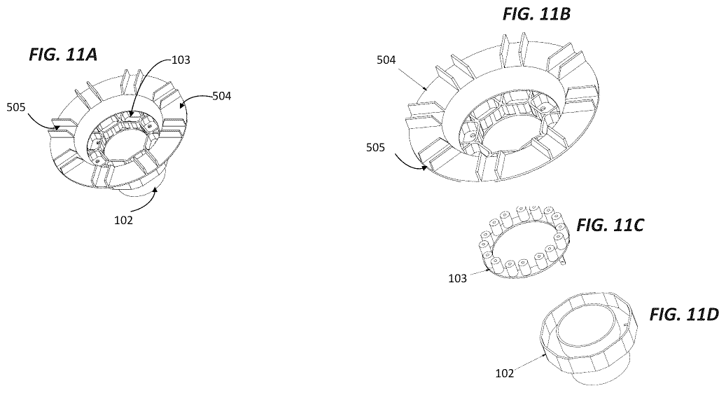

FIG. 11 depicts an enlarged perspective receptacle ring 102 of collar ring 504 and multiple collars 505. In FIG. 11A, collar ring 504 is connected to receptacle ring 102.

Receptacle ring 102 contains receptacles 103. In alternative embodiments, receptacle ring 102 may not be connected to collar ring 504. FIG. 11B depicts an alternative view of collar ring 504 connected to receptacle ring 102. FIG. 11C depicts branch receptacles 103 of the receptacle ring 102. FIG. 11D depicts a base component of receptacle ring 102.

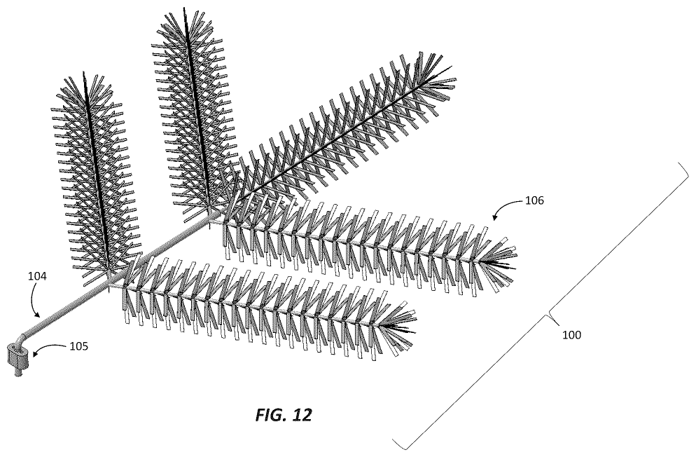

FIG. 12 depicts an alternative embodiment of removably connected branch 100. As shown in the embodiment in FIG. 12, each removably connected branch 100 can include a branch stem 104. In the embodiment show in FIG. 1, the removably connected branch 100 includes branch stem 104, branch connector 105, and twig members 106.

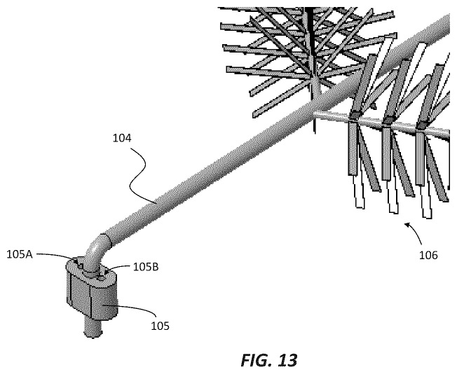

As shown in greater detail in FIG. 13, each of removably connected branch 100 comprises at least one branch connector 105. In the embodiment shown in FIG. 13, the branch connector 105 is an oval shape and is oriented in generally vertical orientation. A person of skill in the art would understand that the branch connector 105 can be configured as a oval, a rectangle, a square, a triangle, or other suitable shapes capable of mating with a corresponding branch receptacle 103. In some embodiments, the branch connector 105 can be comprised of a metal or metal alloy and in other embodiments, the branch connector 105 can be comprised of a hardened plastic or other rigid polymer. As shown in FIG. 13, the branch connector 105 can be disposed on the proximal end of the removably connected branch 100 so as to provide easy engagement with the tree trunk component 101. In the embodiment shown in FIG. 13, the branch connector 105 can provide apertures 105A and 105B.

As shown in the embodiment depicted in FIG. 13, the branch stem 104 of the removably connected branch 100 can be configured with a greater than 90 degree bend in the area of the branch stem 104 that is distal to the branch connector 105. This greater than a 90-degree bend can provide improved weight support for the removably connected branch 100 when mated with the branch receptacle 103 in the tree trunk component 101. Alternatively, the removably connected branch 100 can be configured with a 90-degree bend in the area of the branch stem that is distal to the branch connector 105.

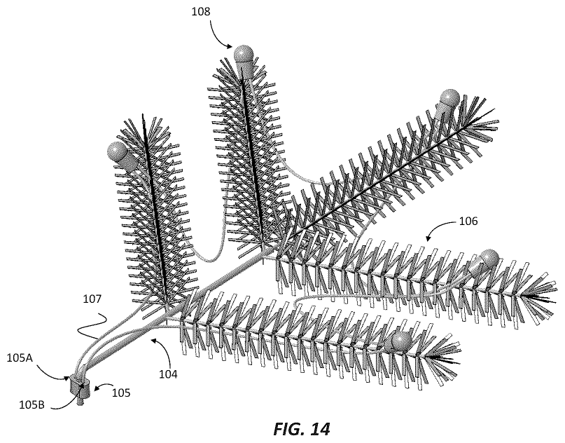

FIG. 14 illustrates an embodiment of the removably connected branch 100 that is pre-strung with lighting components, namely light string 107. In the embodiment shown in FIG. 14, the light string 107 is provided on each of the twig members 106. In alternative embodiments, the light string 107 can be provided on less than all of the twig members 106. Furthermore, the light string 107 includes light components 108, which may be LED lights, incandescent lights, fiber optics, or equivalent lighting components to each of these three. In the embodiment show in in FIG. 14, the light string 107 provides electricity to the light string components 108. Furthermore, in the embodiment shown in FIG. 14, the light string 107 can be strung to pass through apertures 105A and 105B in the branch connector 105.

Alternatively, the lighting elements may be powered wirelessly.

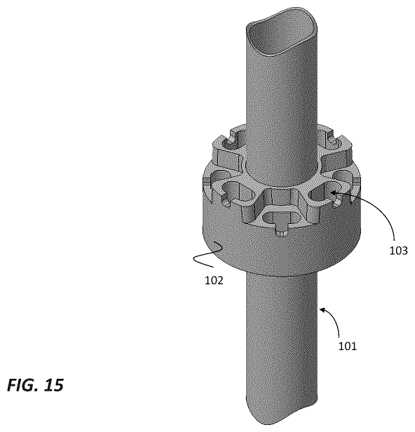

FIG. 15 depicts an embodiment of tree trunk component 101. As shown in FIG. 15, the tree trunk component 101 can provide a receptacle ring 102 and multiple branch receptacles 103.

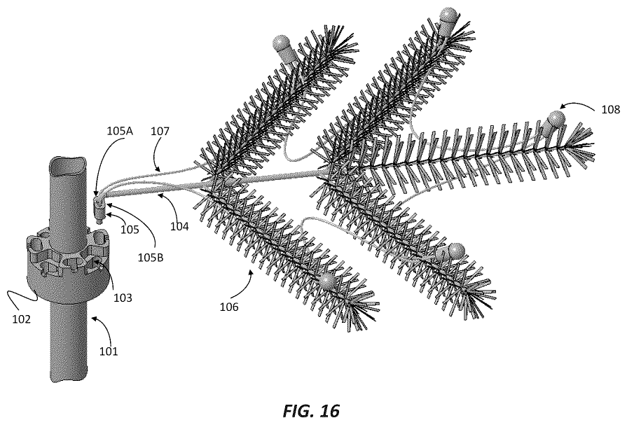

FIG. 16 illustrates an embodiment of the removably connected branch 100 positioned for insertion into the branch receptacle 103 of the receptable ring 102 in communication with tree trunk component 101. As shown in the embodiment in FIG. 16, the branch connector 105 can be inserted into the branch receptacle 103. Furthermore, as shown in the embodiment in FIG. 16, the light string 107 can provided with the branch connector 105 such that an electrical connection can be made when the removably connected branch 100 is inserted into the branch receptacle 103. Accordingly, the removably connected branch 100 provides a convenient and easy way to connect the light string 107 of the branch 100 to a power source. In this embodiment, no further electrical connection is needed to provide power to the light string 107 of the branch 100.

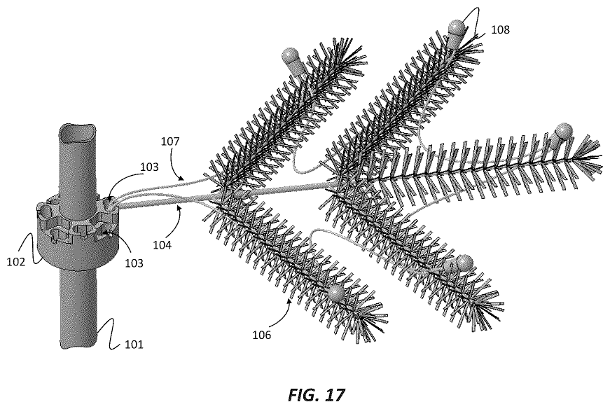

FIG. 17 illustrates an embodiment of the removably connected branch 100 connected to the branch receptacle 103 of the receptable ring 102 in communication with tree trunk component 101. Furthermore, as shown in the embodiment in FIG. 17, the light string 107 can provided with the branch connector 105 such that an electrical connection can be made when the removably connected branch 100 inserted into the branch receptacle 103.

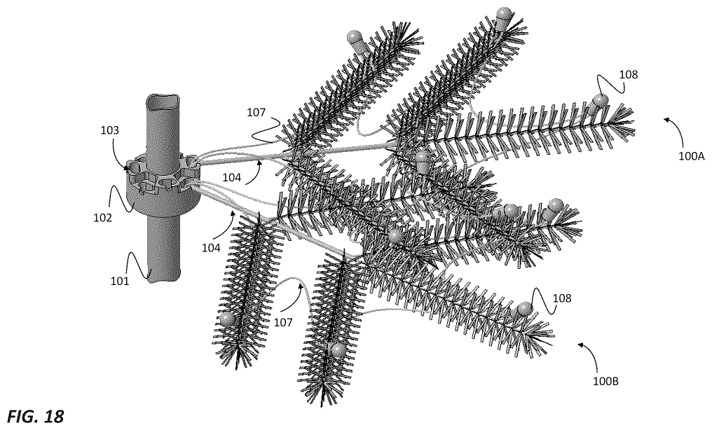

FIG. 18 illustrates an embodiment in which both a first removably connected branch 100A and a second removably connected branch 100B have been inserted into branch receptacles 103 of the receptacle ring 102 in communication with tree trunk component 101. Furthermore, as shown in the embodiment in FIG. 18, the second removably connected branch 100B is configured at a lower height than that of the first removably connected branch 100A. The configuration of different branches 100 at different heights enable the artificial tree to provide a more realistic look.

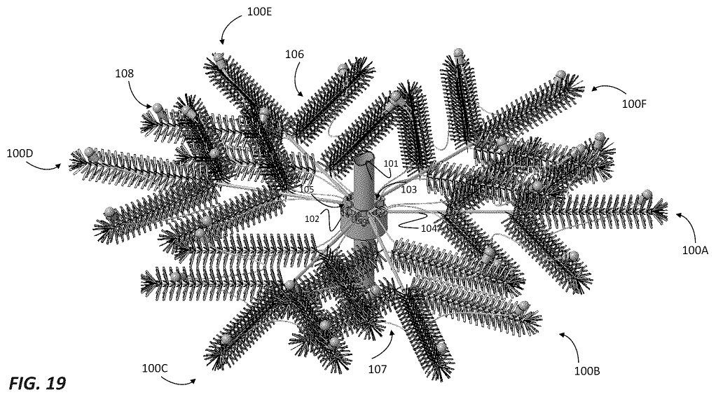

FIG. 19 illustrates an embodiment in which both a first removably connected branch 100A, a second removably connected branch 100B, a third removably connected branch 100C, a fourth removably connected branch 100D, a fifth removably connected branch 100E, and sixth removably connected branch 100F have been inserted into branch receptacles 403 of the receptable ring 402 in communication with tree trunk component 401. Furthermore, as shown in the embodiment in FIG. 19, removably connected branches 100A-100F are configured at alternating heights. The configuration of different branches 100 at different heights enable the artificial tree to provide a more realistic look.

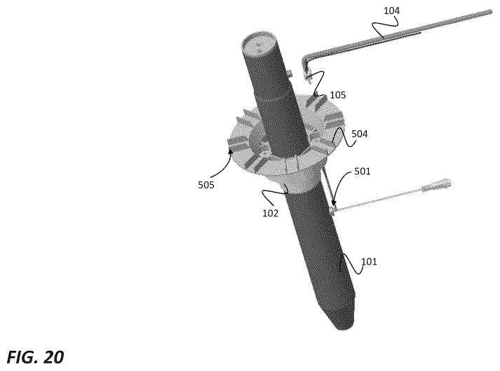

FIG. 20 depicts an alternative embodiment of the receptacle ring 102. The receptacle ring 102 provides collars 505 on collar ring 504 to restrict the lateral movement of the removably connected branches 100. Each collar ring 504 is secured into place on tree trunk component 401 using spring button 501.

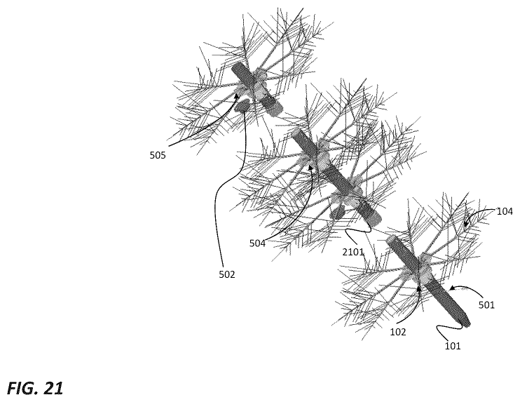

FIG. 21 illustrates as multiple tree trunk components, 101A, 101B, and 101C, having multiple receptacle rings. For the embodiment shown in FIG. 21, the multiple tree trunk components, 101A, 101B, and 101C, can be connected to assemble the artificial tree. A person of ordinary skill would understand that the removably connected branches 100 can be connected to receptacles in the corresponding tree trunk component prior to or after the assembly of the tree trunk components together.

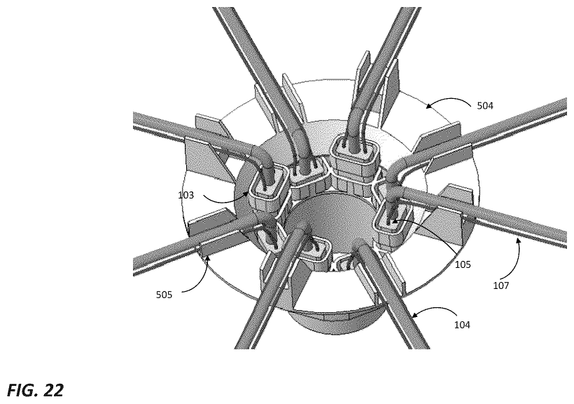

FIG. 22 illustrates how branch stems 104 are inserted into branch receptacles 103 using branch connectors 105. Each branch stem 104 is secured into collars 505 on collar ring 504.

Previous designs of artificial trees are not optimized for storage volume in the disassembled state; thus, such artificial trees typically require relatively large boxes to accommodate the tree design for shipping and storage. Embodiments of the present disclosure allow each removably connected branch to be packed essentially flatly, reducing space when packing the artificial tree. Artificial trees in accordance with embodiments of the present disclosure can be stored or shipped in containers that are no wider than the width of the widest removably connected branch 100 in a compressed configuration. Embodiments of the present disclosure can reduce the amount of unused or open space in the storage container for the artificial tree because the removably connected branches 100 can compressed and stacked on top of each other to minimize the amount of open and unused space in the storage container. Embodiments of the present disclosure can enable more artificial trees to shipped in standard size shipping containers than conventional artificial trees. The reduced shipping and storage volume associated with the embodiments of the present disclosure can reduce shipping costs and reduce energy usage associated with shipping multiple artificial trees.

Previous designs of artificial trees also utilize pre-lit lighting on the trees. This design feature makes it difficult for consumers to replace or repair a tree with lighting issues without replacing section of the tree or even the entire tree. Embodiments of the present disclosure allow consumers to repair or replace only one removably connected branch should lighting issues occur on any one branch. The ability to repair or replace only one branch reduces consumer costs and minimizes potential waste.

In the foregoing specification, embodiments have been described with reference to numerous specific details that can vary from implementation to implementation. Certain adaptations and modifications of the described embodiments can be made. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a module can include A or B, then, unless specifically stated otherwise or infeasible, the module can include A. or B, or A and B. As a second example, if it is stated that a module can include A. B, or C, then, unless specifically stated otherwise or infeasible, the module can include A, or B, or C, or A and B, or A and C, or B and C, or A and B and C.

As used herein, the terms “comprises,” “comprising,” or any other variation thereof are intended to cover a non-exclusive inclusion, such that a process, method, composition, article, or apparatus that comprises a list of elements does not include only those elements but can include other elements not expressly listed or inherent to such process, method, composition, article, or apparatus. The term “exemplary” is used in the sense of “example” rather than “ideal.”

In the drawings and specification, there have been disclosed exemplary embodiments. It will be apparent to those skilled in the art that various modifications and variations can be made to the disclosed apparatuses, systems, and related methods. Other embodiments will be apparent to those skilled in the art from consideration of the specification and practice of the disclosed apparatuses, systems, and related methods. It is intended that the specification and examples be considered as exemplary only, with a true scope being indicated by the following claims and their equivalents.

1. A variable branch artificial tree, comprising:
a first removably connected branch comprising at least one twig member and at least one branch connector;
a tree trunk component comprising a first branch receptacle and a second branch receptacle;
wherein the at least one branch connector of the first removably connected branch can be removably inserted into the first branch receptacle to enable secure coupling of the first removably connected branch and the tree trunk component; and
wherein a first branch receptacle is adjacent to the second branch receptacle and at a different height on the tree trunk component than the second branch receptacle.

2. The variable branch artificial tree of claim 1, further comprising a second removably connected branch comprising at least one twig member and at least one branch connector.

3. The variable branch artificial tree of claim 2,
wherein the at least one branch connector of the second removably connected branch can be removably inserted into the second branch receptacle to enable secure coupling of the second removably connected branch and the tree trunk component;
and
wherein the second removably connected branch is adjacent to the first removably connected branch when coupled to the second branch receptacle and at a different height on the tree trunk component than the first removably connected branch.

4. The variable branch artificial tree of claim 3, further comprising:
a third removably connected branch comprising at least one twig member and at least one branch connector;
wherein tree trunk component further comprises a third branch receptacle; wherein the at least one branch connector of the third removably connected branch can be removably inserted into the third branch receptacle to enable secure coupling of the third removably connected branch and the tree trunk component; and
wherein the third removably connected branch, when coupled to the third branch receptacle, is adjacent to the first removably connected branch and the second removably connected branch and at a different height on the tree trunk component than both the first removably connected branch and the second removably connected branch.

5. The variable branch artificial tree of claim 1, wherein the first removably connected branch further comprises at least one pre-strung light string.

6. The variable branch artificial tree of claim 5, wherein at least one pre-strung light string of the first removably connected branch further comprises at least one light component.

7. The variable branch artificial tree of claim 6, wherein the branch connector of the first removably connected branch comprises a hot terminal and a neutral terminal as termination points for the at least one pre-strung light string.

8. The variable branch artificial tree of claim 7, wherein the first branch receptacle further comprises a hot terminal and a neutral terminal enabled to communicate with the corresponding hot terminal and neutral terminal of the branch connector.

9. The variable branch artificial tree of claim 8, wherein electrical power can be provided the at least one pre-strung light string when the branch connector is coupled to the first branch receptacle.

10. A variable branch artificial tree, comprising:
a tree trunk component comprising a first branch receptacle at a first elevation on the tree trunk component, a second branch receptacle at a second elevation on the tree trunk component, and a third branch receptacle at a third location on the tree trunk component;
a first removably connected branch comprising at least one twig member and a branch connector;
a second removably connected branch comprising at least one twig member and a branch connector;
a third removably connected branch comprising at least one twig member and a branch connector;
wherein the branch connector of the first removably connected branch can be removably inserted into the first branch receptacle to enable secure coupling of the first removably connected branch and the tree trunk component, the branch connector of the second removably connected branch can be removably inserted into the second branch receptacle to enable secure coupling of the second removably connected branch and the tree trunk component, and the branch connector of the third removably connected branch can be removably inserted into the third branch receptacle to enable secure coupling of the third removably connected branch and the tree trunk component; and
wherein first elevation on the tree trunk component is different than the second elevation on the tree trunk component and the third elevation is different than the first elevation and the second elevation.

11. The variable branch artificial tree of claim 10, further comprising a fourth branch receptacle at a fourth elevation on the tree trunk component, and a fourth removably connected branch comprising at least one twig member and a branch connector,
wherein the branch connector of the fourth removably connected branch can be removably inserted into the fourth branch receptacle to enable secure coupling of the fourth removably connected branch and the tree trunk component, and
wherein the fourth elevation on the tree trunk component is different than the first elevation, the second elevation, and the third elevation.

12. The variable branch artificial tree of claim 11, further comprising a fifth branch receptacle at a fifth elevation on the tree trunk component, and a fifth removably connected branch comprising at least one twig member and a branch connector,
wherein the branch connector of the fifth removably connected branch can be removably inserted into the fifth branch receptacle to enable secure coupling of the fifth removably connected branch and the tree trunk component, and
wherein the fifth elevation on the tree trunk component is different than the first elevation, the second elevation, the third elevation, and the fourth elevation.

13. The variable branch artificial tree of claim 10, wherein the distance between the first elevation and the second elevation is a first distance and the distance between the second elevation and the third elevation is a second distance and the first distance is different than the second distance.

14. The variable branch artificial tree of claim 13, wherein the distance between the second elevation and the third elevation is a second distance and the distance between the third elevation and the fourth elevation is a third distance and the second distance is different than the third distance.

15. A method of assembling a variable branch artificial tree, comprising:
providing a first removably connected branch comprising at least one twig member and at least one branch connector;
providing a tree trunk comprising a first branch receptacle; and
inserting the first branch connector into the branch receptacle of the tree trunk component to enable secure coupling of the first removably connected branch and the tree trunk component.

16. The method of assembling a variable branch artificial tree of claim 15, further comprising:
providing a second removably connected branch comprising at least one twig member and at least one branch connector;
providing a tree trunk comprising a second branch receptacle;
inserting the at least one branch connector of the second removably connected branch into the second branch receptacle of the tree trunk component to enable secure coupling of the second removably connected branch and the tree trunk component;
and
wherein a first branch receptacle is adjacent to the second branch receptacle and at a different height on the tree trunk component than the second branch receptacle.

17. The method of assembling a variable branch artificial tree of claim 16, wherein, upon insertion, the second removably connected branch is adjacent to first removably connected branch but a different height on the tree trunk component so as to more closely emulate a natural tree.
